(19) United States
(12) Patent Application Publication
(10) Pub. No.: US 2025/0166037 A1
(43) Pub. Date: May 22, 2025

(54) EMBEDDING-BASED SEARCH OF AN ITEM STORE

(71) Applicant: Shopify Inc., Ottawa (CA)

(72) Inventors: Russ Maschmeyer, Berkeley, CA (US); Eric Andrew Florenzano, San Francisco, CA (US); Brennan Letkeman, Calgary (CA); Diego Macario Bello, Montreal (CA); Daniel Beauchamp, Toronto (CA)

(21) Appl. No.: 18/515,913

(22) Filed: Nov. 21, 2023

(51) Int. Cl. G06Q 30/0601

(52) U.S. Cl. CPC G06Q 30/0627; G06Q 30/0641

(57) ABSTRACT

A computer system obtains a first embedding in an embedding space, where the first embedding represents a first item in an item store. The computer system identifies, based on at least a second embedding representing a second item in the item store, an item from the item store, wherein the second embedding is in the embedding space, and the identified item is identified based on a position of the second embedding in the embedding space relative to a position of the first embedding in the embedding space. The computer system outputs an identification of the identified item.

### TECHNICAL FIELD

This application relates to a search system for an item store, and in particular to searching an item store based on an embedding space.

### BACKGROUND

Many platforms and online marketplaces maintain large repositories of items that are available to users of the platform or marketplace. Browsing a large repository of items can be difficult and time-consuming for users. Each item can have many features, and it can be challenging to navigate these features in an intuitive and personalized way.

### BRIEF DESCRIPTION OF THE DRAWINGS

Detailed descriptions of implementations of the present invention will be described and explained through the use of the accompanying drawings.

FIG. 1 is a block diagram illustrating an environment in which an item search system operates, according to some implementations.

FIG. 2A is a schematic representation of an example first and second embedding in an embedding space.

FIGS. 2B-2D illustrate example embeddings identified based on relationships of the embeddings to a first and second embedding.

FIGS. 3A-3B illustrate example user interfaces that enable a user to explore items within an embedding space between a first item and a second item.

FIG. 4 is a flowchart illustrating a process for identifying items from an item store based on embeddings, according to some implementations.

FIG. 5A is a block diagram of a simplified convolutional neural network, which may be used in examples of the present disclosure.

FIG. 5B is a block diagram of a simplified transformer neural network, which may be used in examples of the present disclosure.

FIG. 6 is a block diagram of an example computing system, which may be used to implement examples of the present disclosure.

FIG. 7 illustrates an example e-commerce platform, according to some implementations.

FIG. 8 illustrates an example home page of an administrator.

FIG. 9 illustrates another implementation of an e-commerce platform.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Many platforms and online marketplaces maintain repositories of items that are available to users. Such item repositories can store items or information about items, including, for example, products offered for sale through an online store, digital music or videos, ebooks, podcasts, images, or articles or blogs. Conventional search systems for content repositories enable users to search for items of interest based on explicit metadata associated with the items, such as a word in a title or description of the item, source or author, date of upload, category labels, etc. However, metadata-based search relies upon items having the metadata by which a user desires to search for an item. Such search can also be unintuitive for users who may not know the correct search terms to use to find a particular item of interest.

To solve these problems, a search system for an item store navigates the item store based on an embedding space associated with the items in the item store. Items within an item store can be represented by embeddings that encode features of each item in a numerical vector. The item search system obtains a first embedding in an embedding space that represents a first item in an item store. Based on at least a second embedding representing a second item in the item store, the item search system identifies an item from the item store, where the identified item is identified based on a position of the second embedding in the embedding space relative to a position of the first embedding in the embedding space. An identification of the identified item is output.

In some aspects, the techniques described herein relate to a non-transitory computer readable storage medium storing executable instructions, execution of which by a processor causing the processor to: obtain a first embedding in an embedding space, the first embedding representing a first item in an item store; identify, based on at least a second embedding representing a second item in the item store, an item from the item store, wherein the second embedding is in the embedding space, and the identified item is identified based on a position of the second embedding in the embedding space relative to a position of the first embedding in the embedding space; and output an identification of the identified item.

In some aspects, the techniques described herein relate to a system including: at least one hardware processor; and at least one non-transitory memory storing instructions, which, when executed by the at least one hardware processor, cause the system to: obtain a first embedding in an embedding space, the first embedding representing a first item in an item store; identify, based on at least a second embedding representing a second item in the item store, an item from the item store, wherein the second embedding is in the embedding space, and the identified item is identified based on a position of the second embedding in the embedding space relative to a position of the first embedding in the embedding space; and output an identification of the identified item.

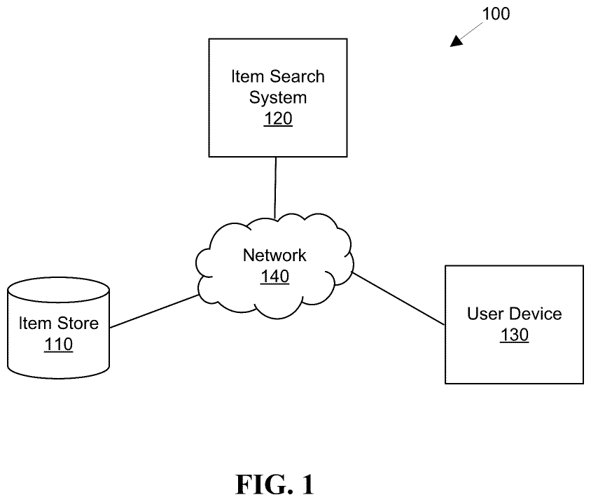

FIG. 1 is a block diagram illustrating an environment in which an item search system operates, according to some implementations. As shown in FIG. 1, the environment can include an item store 110, the item search system 120, and a user device 130, which can communicate with each other over a network 140 such as the Internet.

The item store 110 maintains items or representations of items. Items in the item store 110 can be items that are available through a given online store, marketplace, or platform, such as products offered for sale through an online store or marketplace, digital media available for streaming or download through a media streaming platform, user-generated artwork accessible through an online art sharing platform, or stories or articles accessible through a blogging platform or written content repository. The item store 110 can also represent items aggregated from multiple independent sources by the item search system 120 or by another service. Some implementations of the item store 110 can further be user- or organization-specific, such as a repository of music downloads by a particular user or a business' private document repository.

Each item in the item store 110 can be represented by one or more embeddings. An embedding encodes features of an item as a numerical vector within an embedding space. The embeddings can be generated by a generative artificial intelligence model, such as a generative text model or a generative image model, that processes images or text associated with each item to produce an embedding to represent the item. Alternatively, embeddings can be generated by other transformer-based models, neural networks, or other algorithms that receive features of an item as input and generate a vector representation of the item based on the features. Some items can be represented by more than one embedding. For example, if an item is a physical product being sold through an online marketplace, the item may be associated with an image depicting the product and a textual description of the product. The product can then be represented by a first embedding generated based on the image and a second embedding generated based on the textual description. Similarly, the product can be represented by multiple embeddings generated based on the image alone or the textual description alone, such as multiple embeddings generated by different models or generated based on different aspects of the image or text.

The user device 130 is a computing device used by one or more users to interact with the item store 110 and the item search system 120 to view information about items and to navigate features of items in the item store 110. The user device 130 can include any computing system that is capable of communicating over a network, receiving user inputs, and/or outputting information to a user.

The item search system 120 interfaces with the item store 110 to perform searches of the item store 110. The item search system 120 uses an embedding space associated with items in the item store 110 to identify items that are similar to other items or similar to certain features of other items. A user can interact with the item search system 120 by identifying one or more items that have at least some features of interest to the user. Based on the one or more items identified by the user, the item search system 120 navigates an embedding space to retrieve other items in the item store 110 for output to the user.

Some implementations of the item search system 120 navigate the item store 110 by generating interpolations between two or more items in the item store and finding other items that fall on or near these interpolations. The interpolation method enables the item selection system to explore an embedding space between two items to find items that fall anywhere within this embedding space.

When navigating the item store within an embedding space between two items, the item search system 120 receives a first embedding that represents a first item and a second embedding that represents a second item. The first and second item can be explicitly selected by a user as two items that have at least some features of interest to the user. Alternatively, at least one item can be determined by the item search system 120 as an item of interest to the user based on the user's interactions with items in the item store 110. For example, the item search system 120 can identify, as the first or second item, an item the user has viewed recently or at least a threshold number of times, an item the user has previously purchased or downloaded, an item that is similar to an item that the user has previously acted upon, or an item that has been acted upon by other users who are similar to the user or who have acted upon the same other item as the user. Furthermore, the first and second items need not be items in the item store 110. For example, a user can provide an image of or link to another item that is not available in the item store. At least one of the first item or the second item also can be an image generated by a generative artificial intelligence model that receives a user description of item features of interest and that generates an image of a corresponding item based on the description.

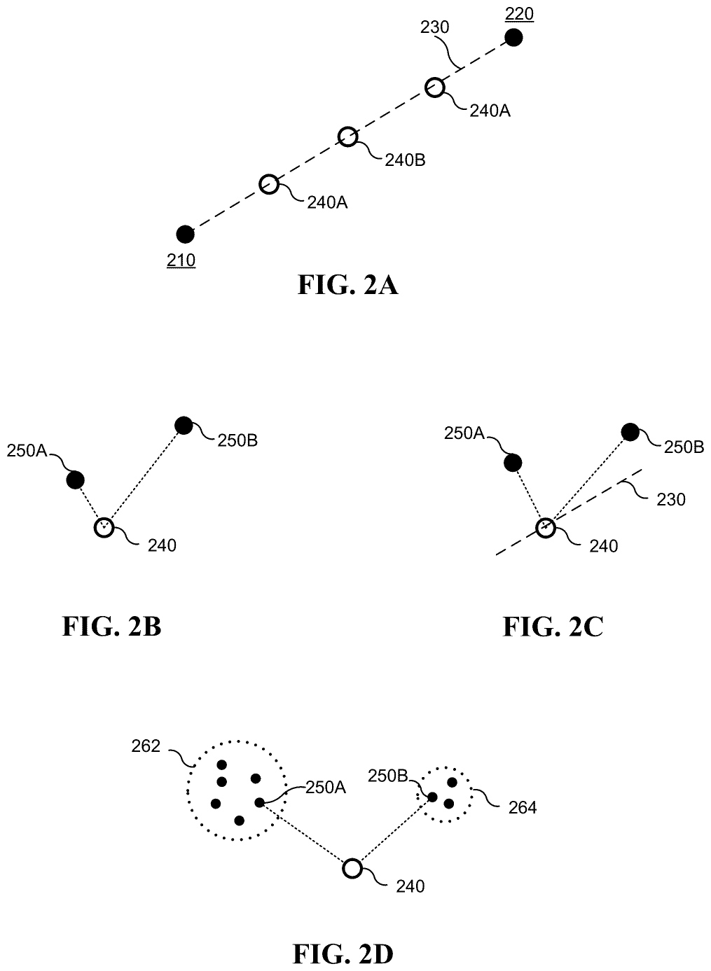

A schematic representation of a first embedding 210 and a second embedding 220 in embedding space is illustrated in FIG. 2A. To navigate the embedding space between the items, the item search system 120 generates an interpolation between the first embedding and the second embedding. As illustrated in FIG. 2A, the interpolation can be a linear interpolation 230 between the first embedding 210 and the second embedding 220. The item search system 120 can generate the linear interpolation between the first and second embeddings in their full dimensionality, or can project the first and second embeddings to a reduced-dimensionality vector space before interpolating between the lower-dimension embeddings. Alternatively, the item search system 120 can generate a non-linear interpolation, such as a hermite or other polynomial-based interpolation, between the first and second embeddings.

The item search system 120 may divide the interpolation into one or more points (e.g., points 240 as shown in FIG. 2A). Such points can be determined by, for example, dividing the interpolation into a specified number of points or dividing the interpolation into points with a specified distance between each point. The number of points or size of step between the points can be selected based on a distance between the first embedding and the second embedding, in some cases. For smaller distances between the first embedding and second embedding, the item search system 120 can use a smaller number of points or a smaller size of steps between points, while a greater number of points or greater step size are used for larger distances between the two embeddings.

At each of one or more points along the interpolation, the item search system 120 identifies a third embedding based on a distance between the third embedding and the point. Distance between an embedding and the point can be measured using any of a variety of distance metrics, including, for example, Euclidean distance, cosine similarity, Minkowski distance, or Chebyshev distance. For example, the item search system 120 performs a vector search of the item store 110 to identify an embedding near the point on the interpolation. When identifying the third embedding, the item search system 120 can, in various implementations, retrieve an embedding that is nearest to the point, for example based on a Euclidean distance between the embedding and the point. FIG. 2B illustrates an example in which an embedding 250A is selected as the third embedding instead of an embedding 250B, since the embedding 250A has a lower Euclidean distance to a point 240 along the interpolation than the embedding 250B. In other implementations, the item search system 120 selects a third embedding based on a combination of distance metrics. FIG. 2C illustrates an example in which an embedding 250A has a smaller Euclidean distance to the point 240 than the embedding 250B, but the embedding 250B is closer to the interpolation 230 between the first and second embeddings (e.g., such that the embedding 250B has a greater cosine similarity to the first embedding, the second embedding, or the point 240). In this example, the item search system 120 may select the embedding 250B as the third embedding when it is both within a threshold Euclidean distance of the point 240 and has the greatest cosine similarity to the point, the first embedding, or the second embedding.

When multiple embeddings are within a threshold distance to the point along the interpolation, the item search system 120 may apply one or more rules to select the third embedding from among the multiple candidate embeddings. In some implementations, the item search system 120 evaluates attributes of the items represented by the candidate embeddings to select the third embedding from among the candidates. Attributes can include, for example, a rating of the item, a rating of a seller/author/source of the item, a number of views of the item, an age of the item, or a number of sales or downloads of the item. The item search system 120 can select the third embedding as an embedding that corresponds to the item with certain attribute data, such as an embedding for which the corresponding item has the highest rating, a highest number of views, or a highest number of sales. In other implementations, the item search system 120 uses a clustering algorithm to identify one or more clusters of embeddings that include at least one embedding within a threshold distance of each point. From these clusters, a third embedding can be selected based on properties of the cluster. FIG. 2D illustrates an example in which the item search system 120 identifies a first cluster 262 of embeddings and a second cluster 264 of embeddings, where the first cluster 262 is a larger cluster than the second. In this example, the item search system 120 can select an embedding that is within the larger cluster 262 (such as the embedding 250A), since the larger cluster indicates that the item corresponding to the embedding 250A is likely to be a more popular item than items whose embeddings belong to smaller clusters (e.g., an item corresponding to embedding 250B).

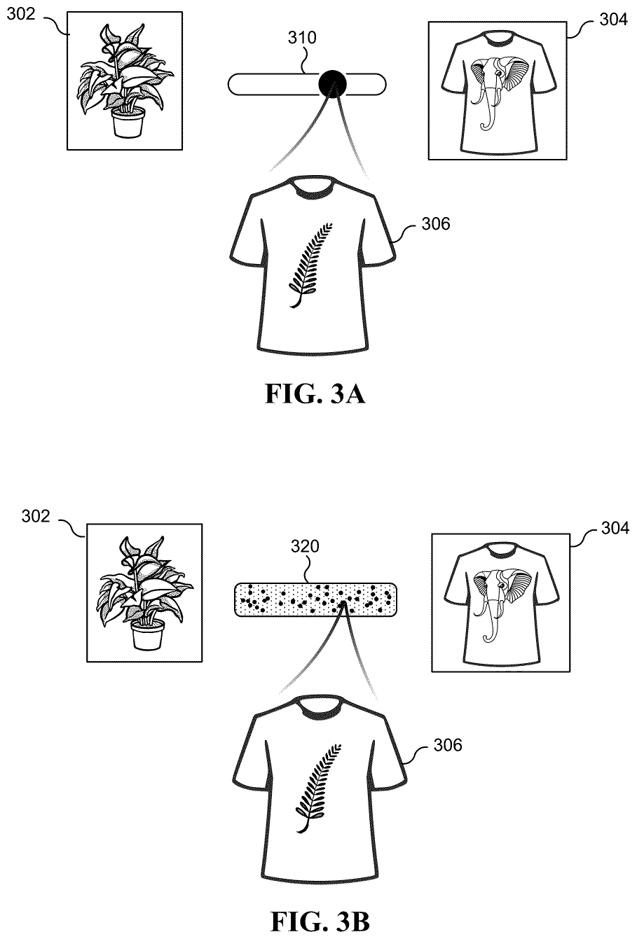

Once the third embedding has been selected, the item search system 120 can output an identification of a third item that is represented by the third embedding. A variety of different user interfaces can be used to output the third item. FIGS. 3A and 3B illustrate example user interfaces that enable a user to explore items within an embedding space between a first item 302, a potted plant, and a second item 304, a t-shirt with a picture of an elephant. In the example illustrated in FIG. 3A, the system presents a slider 310 that is manipulable to represent a corresponding location within an embedding space between a first embedding associated with the first item 302 and a second embedding associated with the second item 304. When a user manipulates a position of the slider 310, the system displays an image of an item 306 in the item repository for which the item's embedding approximately corresponds to the location in the vector space that is represented by the slider's position. A user can therefore manipulate the slider to see items that are more similar to the first item, more similar to the second item, or somewhere in the middle between the items, such as the t-shirt with a picture of a plant illustrated in FIG. 3A. In the example illustrated in FIG. 3B, an interactive representation 320 of the embedding space is presented. Within the interactive representation, one or more indicators for respective third items are displayed at positions within the interactive representation that correspond to relative distances between respective third embeddings and the first embedding or the second embedding. A user can then select any of these indicators, in response to which the system displays an image of the item 306 that corresponds to the selected indicator. The interactive representation can show a multi-dimensional embedding space, in some cases, to allow a user to interact with items whose embeddings are a short distance away from the interpolation between the first and second embeddings.

Some implementations of the item search system 120 navigate the item store 110 by traversing a feature dimension within the embedding space. When the system obtains a selection of a feature dimension, the system can identify an item for which an embedding representing the item is within a threshold distance of a corresponding feature of another item along the selected feature dimension.

The item search system 120 can cause a plurality of feature dimensions to be output to a user, enabling the user to select a feature dimension of interest. To identify the feature dimensions based on an embedding or set of embeddings, the item search system 120 can employ a generative artificial intelligence model (such as a large language model or a generative image model) that is configured to output a descriptor for features of an item based on an embedding that represents the item. Alternatively, the item search system 120 can identify feature dimensions of the item by decomposing aesthetic concepts of an item using a model that is trained to map latent space representations of an item to an aesthetic category of the item.

The feature dimensions can be output to a user via any of a variety of interactive interfaces. In one example, the item search system 120 outputs an image or textual description for each of one or more feature dimensions. Associated with each of the feature dimensions can be a manipulable element (e.g., a button, a radio dial, a check box, etc.). A user can interact with the manipulable element to specify features of interest to the user or features that are not of interest to the user.

Another example interface for receiving user selections of features of interest includes a slider for each of one or more feature dimensions. Each slider is manipulable to select a degree of a feature dimension to apply to a search of the item store. As described above, the item search system 120 can identify a second item that is likely to interest a user based on an embedding associated with the second item being within a threshold distance of a corresponding feature of a first item along a user-selected dimension. The threshold distance between the second embedding and the selected dimension can be determined based on a position of the slider as manipulated. For example, if the slider is manipulated to its maximum position, this indicates that the user would prefer an item that has the corresponding feature. Thus, the threshold distance permissible between the second item and the corresponding feature dimension is low. On the other hand, if the slider is manipulated to its minimum position, the user may be agnostic to the feature and thus may be interested in items at any distance from the corresponding dimension.

Still another example interface for receiving user feature selections includes a circular grid, where multiple feature dimensions are presented on the circular grid at different angular positions around the grid. A marker displayed on the grid is manipulable to select a location on the grid, and thus a relative degree of each feature dimension. A threshold distance between the second embedding and at least one of the feature dimensions can be determined based on the selected location of the marker on the circular grid.

Once a user selects a dimension of interest from among the feature dimensions presented by the item search system 120, the item search system 120 identifies a second item from the item repository. The second item can be identified based on a second embedding associated with the second item having a second feature that is within a threshold distance of the selected feature in an embedding space, wherein distance is measured, for example, as a Euclidean distance between the second feature and the selected feature, a cosine similarity between the second feature and the selected feature, or using any of a variety of other distance or similarity metrics. In an example, if the first item is a shirt with a photo of a cactus on it, the feature dimension of interest to the user may be the picture of the cactus. If the user selects this feature dimension, the item search system 120 performs a vector search of the item repository to identify and present other items that have features within a threshold distance of this feature. Such items may include, for example, other shirts with cactus photos that are different colors or prices than the first shirt, another shirt with a drawing of a cartoon cactus, a mug with a photo of a cactus, a bag with a photo or drawing of a cactus, a cactus-shaped vase, or a shirt with a photo of a flower. Once the second item has been selected, an identifier of the second item, such as an image of the item, can be presented to the user.

In addition to or instead of the user explicitly selecting a feature dimension of interest to the user, the item search system 120 can receive an indication that the user is agnostic to a particular dimension. For example, the user may not care about the price of an item or may be interested in any cactus picture, regardless of the type of item on which the cactus picture appears. The item search system 120 correspondingly identifies the second item based on the second embedding being within a threshold distance of feature dimensions other than the feature dimension to which the user is agnostic.

Furthermore, some implementations of the item search system 120 can determine a feature of interest to a user (or a feature to which a user is agnostic) based on user actions other than a direct selection of the feature. For example, a user can explicitly identify another item from the item store as an item of interest or the item search system 120 can determine that another item is of interest to the user based on the user's interactions with the item or with other items similar to the item. The item search system 120 determines a similarity between the embedding of the first item and the embedding of the other item to identify a similar feature shared by the two items. The feature dimension that is traversed to identify other items in the item store can include at least the feature that is similar between the first item and the other user-selected item.

### Navigating an Item Store Based on an Embedding Space

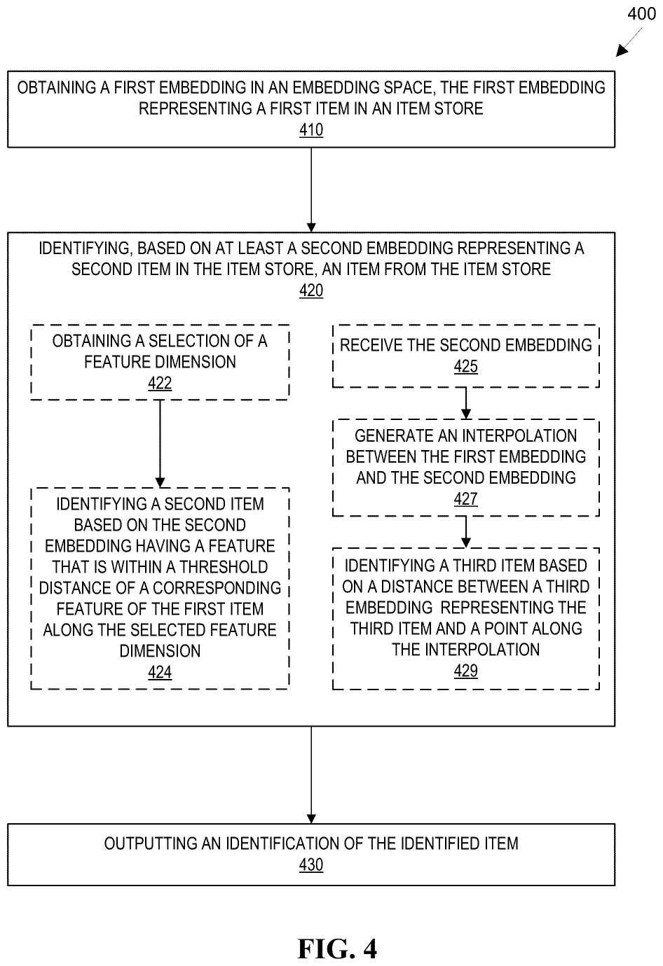

FIG. 4 is a flowchart illustrating a process 400 for identifying items from an item store based on embeddings, according to some implementations. The process 400 can be performed by a computer system, such as the item search system 120. Other implementations of the process can include additional, fewer, or different steps, or can perform the steps in different orders.

At step 410, the computer system obtains a first embedding in an embedding space. The first embedding can represent a first item in an item store, and the first item can be an item explicitly selected by a user or an item that is selected by the computer system based on user interactions with items in the item store.

At step 420, the computer system identifies, based on at least a second embedding representing a second item in the item store, an item from the item store. In general, the computer system can identify the identified item based on a position of the second embedding in the embedding space relative to a position of the first embedding in the embedding space.

In some implementations, the identified item can be the second item. To identify the second item, the computer system obtains, at step 422, a selection of a feature dimension. A description of a set of feature dimensions can be output to a user for the user to select a desired feature dimension, or the computer system can automatically select a feature dimension based on user interactions with items in the item store. At step 424, the computer system identifies the second item based on the second embedding having a feature that is within a threshold distance of a corresponding feature of the first item along the selected feature dimension.

In other implementations, the item identified at step 420 is a third item that is different from the first item and the second item. To identify the third item, the computer system can receive the second embedding, at step 425. For example, a user provides an input to identify the second item as an item of interest, and the computer system retrieves the second embedding representing the second item based on the user's selection.

At step 427, the computer system generates an interpolation between the first embedding and the second embedding. The computer system can then identify, at step 429, a third item based on a distance between a third embedding that represents the third item and a point along the interpolation.

Finally, at step 430, the computer system outputs an identification of the identified item, such as an image of the item.

The computer system can iterate through steps of the process 400 to progressively navigate through an embedding space associated with items in the item store. For example, after identifying the identified item, the computer system determines a point along the selected feature dimension that is further from the first embedding than the identified item (that is, a point along the dimension that has a greater distance to the first embedding than a distance between the identified item's embedding and the first embedding). Another item in the item store can then be identified and output based on a position of the other item's embedding relative to the determined point. This process can be repeated as the computer system progressively moves along the selected feature dimension to find additional items that are further from the first embedding but still along the selected feature dimension. Likewise, instead of stepping along the selected feature dimension, the computer system can iteratively step through points along an interpolation between two embeddings to identify items based on their position relative to the embedding space between the two embeddings.

### Neural Networks and Machine Learning

To assist in understanding the present disclosure, some concepts relevant to neural networks and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g. each data entry in the training dataset may be paired with a label), or may be unlabeled.

Training a ML model generally involves inputting into an ML model (e.g. an untrained ML model) training data to be processed by the ML model, processing the training data using the ML model, collecting the output generated by the ML model (e.g. based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publicly-available text corpuses may be, e.g., fine-tuned by further training using the complete works of Shakespeare as training data samples (e.g., where the intended use of the ML model is generating a scene of a play or other textual content in the style of Shakespeare).

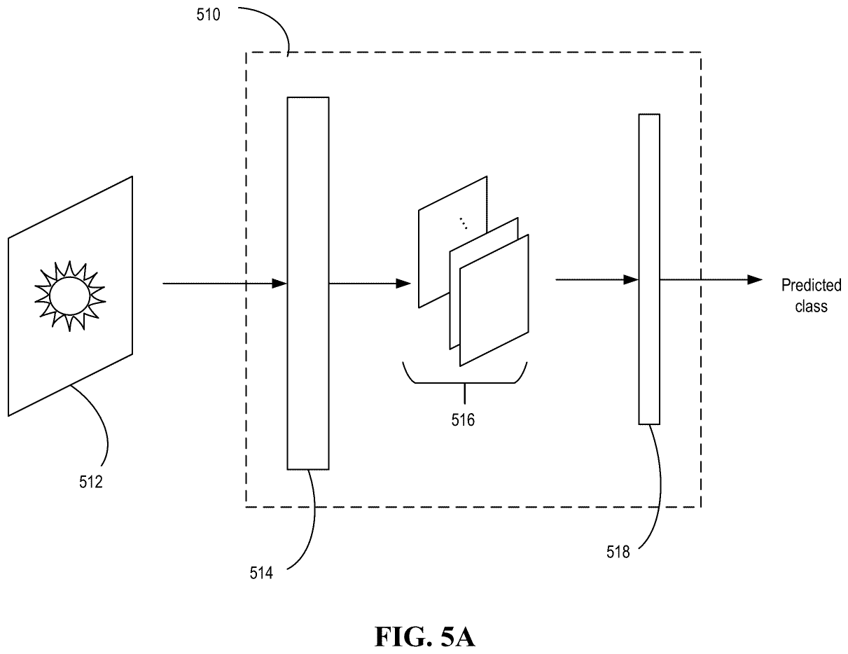

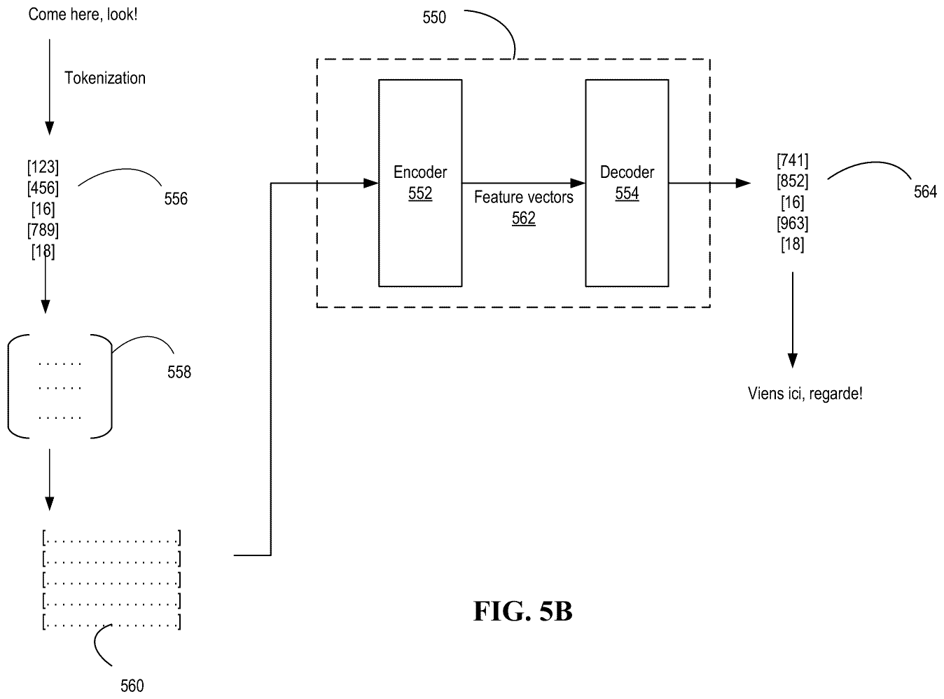

FIG. 5A is a simplified diagram of an example CNN 510, which is an example of a DNN that is commonly used for image processing tasks such as image classification, image analysis, object segmentation, etc. An input to the CNN 510 may be a 2D RGB image 512.

The CNN 510 includes a plurality of layers that process the image 512 in order to generate an output, such as a predicted classification or predicted label for the image 512. For simplicity, only a few layers of the CNN 510 are illustrated including at least one convolutional layer 514. The convolutional layer 514 performs convolution processing, which may involve computing a dot product between the input to the convolutional layer 514 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 514 is a set of feature maps 516 (sometimes referred to as activation maps). Each feature map 516 generally has smaller width and height than the image 512. The set of feature maps 516 encode image features that may be processed by subsequent layers of the CNN 510, depending on the design and intended task for the CNN 510. In this example, a fully connected layer 518 processes the set of feature maps 516 in order to perform a classification of the image, based on the features encoded in the set of feature maps 516. The fully connected layer 518 contains learned parameters that, when applied to the set of feature maps 516, outputs a set of probabilities representing the likelihood that the image 512 belongs to each of a defined set of possible classes. The class having the highest probability may then be outputted as the predicted classification for the image 512.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 5B is a simplified diagram of an example transformer 550, and a simplified discussion of its operation is now provided. The transformer 550 includes an encoder 552 (which may comprise one or more encoder layers/blocks connected in series) and a decoder 554 (which may comprise one or more decoder layers/blocks connected in series). Generally, the encoder 552 and the decoder 554 each include a plurality of neural network layers, at least one of which may be a self-attention layer. The parameters of the neural network layers may be referred to as the parameters of the language model.

The transformer 550 may be trained on a text corpus that is labelled (e.g., annotated to indicate verbs, nouns, etc.) or unlabelled. LLMs may be trained on a large unlabelled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 550 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 5B, a short sequence of tokens 556 corresponding to the text sequence “Come here, look!” is illustrated as input to the transformer 550. Tokenization of the text sequence into the tokens 556 may be performed by some pre-processing tokenization module such as, for example, a byte pair encoding tokenizer (the “pre” referring to the tokenization occurring prior to the processing of the tokenized input by the LLM), which is not shown in FIG. 5B for simplicity. In general, the token sequence that is inputted to the transformer 550 may be of any length up to a maximum length defined based on the dimensions of the transformer 550 (e.g., such a limit may be 2048 tokens in some LLMs). Each token 556 in the token sequence is converted into an embedding vector 560 (also referred to simply as an embedding). An embedding 560 is a learned numerical representation (such as, for example, a vector) of a token that captures some semantic meaning of the text segment represented by the token 556. The embedding 560 represents the text segment corresponding to the token 556 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 560 corresponding to the “look” token will be closer to another embedding corresponding to the “see” token in the vector space, as compared to the distance between the embedding 560 corresponding to the “look” token and another embedding corresponding to the “cake” token. The vector space may be defined by the dimensions and values of the embedding vectors. Various techniques may be used to convert a token 556 to an embedding 560. For example, another trained ML model may be used to convert the token 556 into an embedding 560. In particular, another trained ML model may be used to convert the token 556 into an embedding 560 in a way that encodes additional information into the embedding 560 (e.g., a trained ML model may encode positional information about the position of the token 556 in the text sequence into the embedding 560). In some examples, the numerical value of the token 556 may be used to look up the corresponding embedding in an embedding matrix 558 (which may be learned during training of the transformer 550).

The generated embeddings 560 are input into the encoder 552. The encoder 552 serves to encode the embeddings 560 into feature vectors 562 that represent the latent features of the embeddings 560. The encoder 552 may encode positional information (i.e., information about the sequence of the input) in the feature vectors 562. The feature vectors 562 may have very high dimensionality (e.g., on the order of thousands or tens of thousands), with each element in a feature vector 562 corresponding to a respective feature. The numerical weight of each element in a feature vector 562 represents the importance of the corresponding feature. The space of all possible feature vectors 562 that can be generated by the encoder 552 may be referred to as the latent space or feature space.

Conceptually, the decoder 554 is designed to map the features represented by the feature vectors 562 into meaningful output, which may depend on the task that was assigned to the transformer 550. For example, if the transformer 550 is used for a translation task, the decoder 554 may map the feature vectors 562 into text output in a target language different from the language of the original tokens 556. Generally, in a generative language model, the decoder 554 serves to decode the feature vectors 562 into a sequence of tokens. The decoder 554 may generate output tokens 564 one by one. Each output token 564 may be fed back as input to the decoder 554 in order to generate the next output token 564. By feeding back the generated output and applying self-attention, the decoder 554 is able to generate a sequence of output tokens 564 that has sequential meaning (e.g., the resulting output text sequence is understandable as a sentence and obeys grammatical rules). The decoder 554 may generate output tokens 564 until a special [EOT] token (indicating the end of the text) is generated. The resulting sequence of output tokens 564 may then be converted to a text sequence in post-processing. For example, each output token 564 may be an integer number that corresponds to a vocabulary index. By looking up the text segment using the vocabulary index, the text segment corresponding to each output token 564 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed or pre-processed into a token sequence prior to being provided as input to the LLM via its API. A prompt can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

FIG. 2 illustrates an example computing system 600, which may be used to implement examples of the present disclosure, such as a prompt generation engine to generate prompts to be provided as input to a language model such as a LLM. Additionally or alternatively, one or more instances of the example computing system 600 may be employed to execute the LLM. For example, a plurality of instances of the example computing system 600 may cooperate to provide output using an LLM in manners as discussed above.

The example computing system 600 includes at least one processing unit, such as a processor 602, and at least one physical memory 604. The processor 602 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 604 may include a volatile or non-volatile memory (e.g., a flash memory, a random access memory (RAM), and/or a read-only memory (ROM)). The memory 604 may store instructions for execution by the processor 602, to the computing system 600 to carry out examples of the methods, functionalities, systems and modules disclosed herein.

The computing system 600 may also include at least one network interface 606 for wired and/or wireless communications with an external system and/or network (e.g., an intranet, the Internet, a P2P network, a WAN and/or a LAN). A network interface may enable the computing system 600 to carry out communications (e.g., wireless communications) with systems external to the computing system 600, such as a language model residing on a remote system.

The computing system 600 may optionally include at least one input/output (1/O) interface 608, which may interface with optional input device(s) 610 and/or optional output device(s) 612. Input device(s) 610 may include, for example, buttons, a microphone, a touchscreen, a keyboard, etc. Output device(s) 612 may include, for example, a display, a speaker, etc. In this example, optional input device(s) 610 and optional output device(s) 612 are shown external to the computing system 600. In other examples, one or more of the input device(s) 610 and/or output device(s) 612 may be an internal component of the computing system 600.

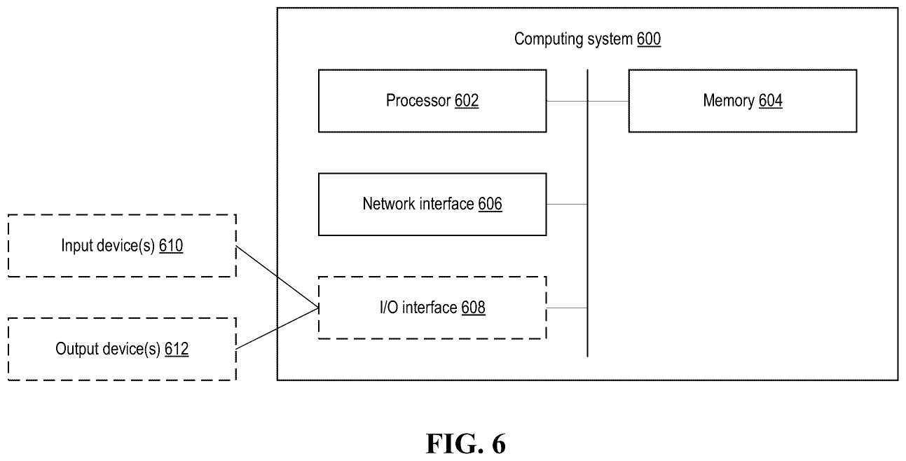

A computing system, such as the computing system 600 of FIG. 6, may access a remote system (e.g., a cloud-based system) to communicate with a remote language model or LLM hosted on the remote system such as, for example, using an application programming interface (API) call. The API call may include an API key to enable the computing system to be identified by the remote system. The API call may also include an identification of the language model or LLM to be accessed and/or parameters for adjusting outputs generated by the language model or LLM, such as, for example, one or more of a temperature parameter (which may control the amount of randomness or “creativity” of the generated output) (and/or, more generally some form of random seed as serves to introduce variability or variety into the output of the LLM), a minimum length of the output (e.g., a minimum of 10 tokens) and/or a maximum length of the output (e.g., a maximum of 1000 tokens), a frequency penalty parameter (e.g., a parameter which may lower the likelihood of subsequently outputting a word based on the number of times that word has already been output), a “best of” parameter (e.g., a parameter to control the number of times the model will use to generate output after being instructed to, e.g., produce several outputs based on slightly varied inputs). The prompt generated by the computing system is provided to the language model or LLM and the output (e.g., token sequence) generated by the language model or LLM is communicated back to the computing system. In other examples, the prompt may be provided directly to the language model or LLM without requiring an API call. For example, the prompt could be sent to a remote LLM via a network such as, for example, as or in message (e.g., in a payload of a message).

### An Example E-commerce Platform

In an example use of the implementations described herein, the item search system 120 is used to search a store of products in an online marketplace. Although integration with a commerce platform is not required, in some implementations, the methods disclosed herein may be performed on or in association with a commerce platform such as an e-commerce platform. Therefore, an example of a commerce platform will be described.

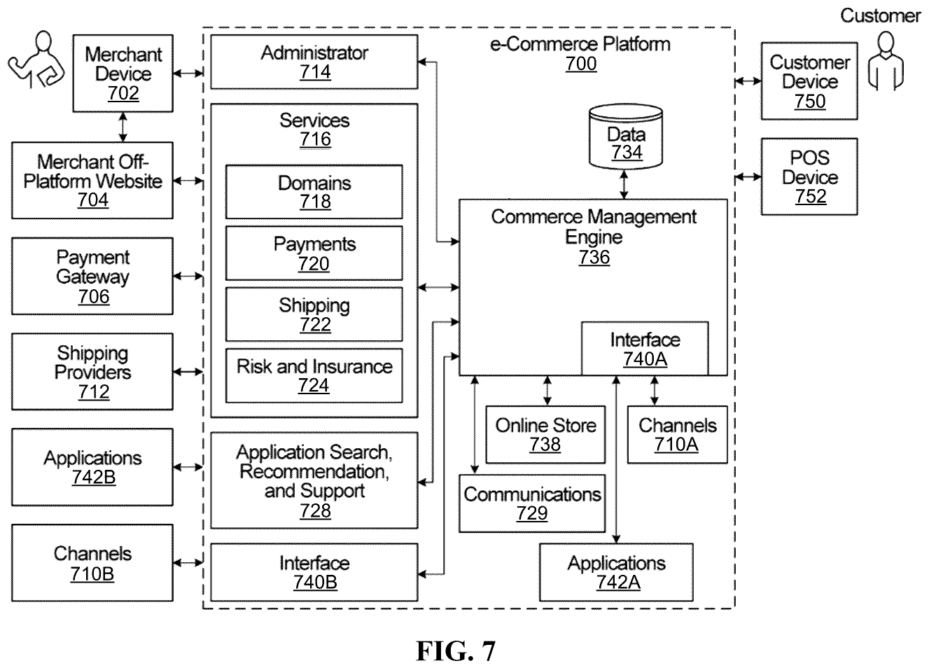

FIG. 7 illustrates an example e-commerce platform 700, according to one embodiment. The e-commerce platform 700 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 700 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 700 for potential use in marketing and selling products, and the like), a service provider user (e.g., a shipping provider 712, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 700 provides merchants with online services/facilities to manage their business. The facilities described herein are shown implemented as part of the platform 700 but could also be configured separately from the platform 700, in whole or in part, as stand-alone services. Furthermore, such facilities may, in some embodiments, may, additionally or alternatively, be provided by one or more providers/entities.

In the example of FIG. 7, the facilities are deployed through a machine, service or engine that executes computer software, modules, program codes, and/or instructions on one or more processors which, as noted above, may be part of or external to the platform 700. Merchants may utilize the e-commerce platform 700 for enabling or managing commerce with customers, such as by implementing an e-commerce experience with customers through an online store 738, applications 742A-B, channels 710A-B, and/or through point of sale (POS) devices 752 in physical locations (e.g., a physical storefront or other location such as through a kiosk, terminal, reader, printer, 3D printer, and the like). A merchant may utilize the e-commerce platform 700 as a sole commerce presence with customers, or in conjunction with other merchant commerce facilities, such as through a physical store (e.g., ‘brick-and-mortar’ retail stores), a merchant off-platform website 704 (e.g., a commerce Internet website or other internet or web property or asset supported by or on behalf of the merchant separately from the e-commerce platform 700), an application 742B, and the like. However, even these ‘other’ merchant commerce facilities may be incorporated into or communicate with the e-commerce platform 700, such as where POS devices 752 in a physical store of a merchant are linked into the e-commerce platform 700, where a merchant off-platform website 704 is tied into the e-commerce platform 700, such as, for example, through ‘buy buttons’ that link content from the merchant off platform website 704 to the online store 738, or the like.

The online store 738 may represent a multi-tenant facility comprising a plurality of virtual storefronts. In embodiments, merchants may configure and/or manage one or more storefronts in the online store 738, such as, for example, through a merchant device 702 (e.g., computer, laptop computer, mobile computing device, and the like), and offer products to customers through a number of different channels 710A-B (e.g., an online store 738; an application 742A-B; a physical storefront through a POS device 752; an electronic marketplace, such, for example, through an electronic buy button integrated into a website or social media channel such as on a social network, social media page, social media messaging system; and/or the like). A merchant may sell across channels 710A-B and then manage their sales through the e-commerce platform 700, where channels 710A may be provided as a facility or service internal or external to the e-commerce platform 700. A merchant may, additionally or alternatively, sell in their physical retail store, at pop ups, through wholesale, over the phone, and the like, and then manage their sales through the e-commerce platform 700. A merchant may employ all or any combination of these operational modalities. Notably, it may be that by employing a variety of and/or a particular combination of modalities, a merchant may improve the probability and/or volume of sales. Throughout this disclosure the terms online store 738 and storefront may be used synonymously to refer to a merchant's online e-commerce service offering through the e-commerce platform 700, where an online store 738 may refer either to a collection of storefronts supported by the e-commerce platform 700 (e.g., for one or a plurality of merchants) or to an individual merchant's storefront (e.g., a merchant's online store).

In some embodiments, a customer may interact with the platform 700 through a customer device 750 (e.g., computer, laptop computer, mobile computing device, or the like), a POS device 752 (e.g., retail device, kiosk, automated (self-service) checkout system, or the like), and/or any other commerce interface device known in the art. The e-commerce platform 700 may enable merchants to reach customers through the online store 738, through applications 742A-B, through POS devices 752 in physical locations (e.g., a merchant's storefront or elsewhere), to communicate with customers via electronic communication facility 729, and/or the like so as to provide a system for reaching customers and facilitating merchant services for the real or virtual pathways available for reaching and interacting with customers.

In some embodiments, and as described further herein, the e-commerce platform 700 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 700 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 700, merchant devices 702, payment gateways 706, applications 742A-B, channels 710A-B, shipping providers 712, customer devices 750, point of sale devices 752, etc. In some implementations, the processing facility may be or may include one or more such computing devices acting in concert. For example, it may be that a plurality of co-operating computing devices serves as/to provide the processing facility. The e-commerce platform 700 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 738) is provided as a service, and is centrally hosted (e.g., and then accessed by users via a web browser or other application, and/or through customer devices 750, POS devices 752, and/or the like). In some embodiments, elements of the e-commerce platform 700 may be implemented to operate and/or integrate with various other platforms and operating systems.

In some embodiments, the facilities of the e-commerce platform 700 (e.g., the online store 738) may serve content to a customer device 750 (using data 734) such as, for example, through a network connected to the e-commerce platform 700. For example, the online store 738 may serve or send content in response to requests for data 734 from the customer device 750, where a browser (or other application) connects to the online store 738 through a network using a network communication protocol (e.g., an internet protocol). The content may be written in machine readable language and may include Hypertext Markup Language (HTML), template language, JavaScript, and the like, and/or any combination thereof.

In some embodiments, online store 738 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 738 by changing their theme while having the same underlying product and business data shown within the online store's product information. It may be that themes can be further customized through a theme editor, a design interface that enables users to customize their website's design with flexibility. Additionally or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 738, such as through blogs, articles, landing pages, and the like, as well as configure navigation menus. Merchants may upload images (e.g., for products), video, content, data, and the like to the e-commerce platform 700, such as for storage by the system (e.g., as data 734). In some embodiments, the e-commerce platform 700 may provide functions for manipulating such images and content such as, for example, functions for resizing images, associating an image with a product, adding and associating text with an image, adding an image for a new product variant, protecting images, and the like.

As described herein, the e-commerce platform 700 may provide merchants with sales and marketing services for products through a number of different channels 710A-B, including, for example, the online store 738, applications 742A-B, as well as through physical POS devices 752 as described herein. The e-commerce platform 700 may, additionally or alternatively, include business support services 716, an administrator 714, a warehouse management system, and the like associated with running an on-line business, such as, for example, one or more of providing a domain registration service 718 associated with their online store, payment services 720 for facilitating transactions with a customer, shipping services 722 for providing customer shipping options for purchased products, fulfillment services for managing inventory, risk and insurance services 724 associated with product protection and liability, merchant billing, and the like. Services 716 may be provided via the e-commerce platform 700 or in association with external facilities, such as through a payment gateway 706 for payment processing, shipping providers 712 for expediting the shipment of products, and the like.

In some embodiments, the e-commerce platform 700 may be configured with shipping services 722 (e.g., through an e-commerce platform shipping facility or through a third-party shipping carrier), to provide various shipping-related information to merchants and/or their customers such as, for example, shipping label or rate information, real-time delivery updates, tracking, and/or the like.

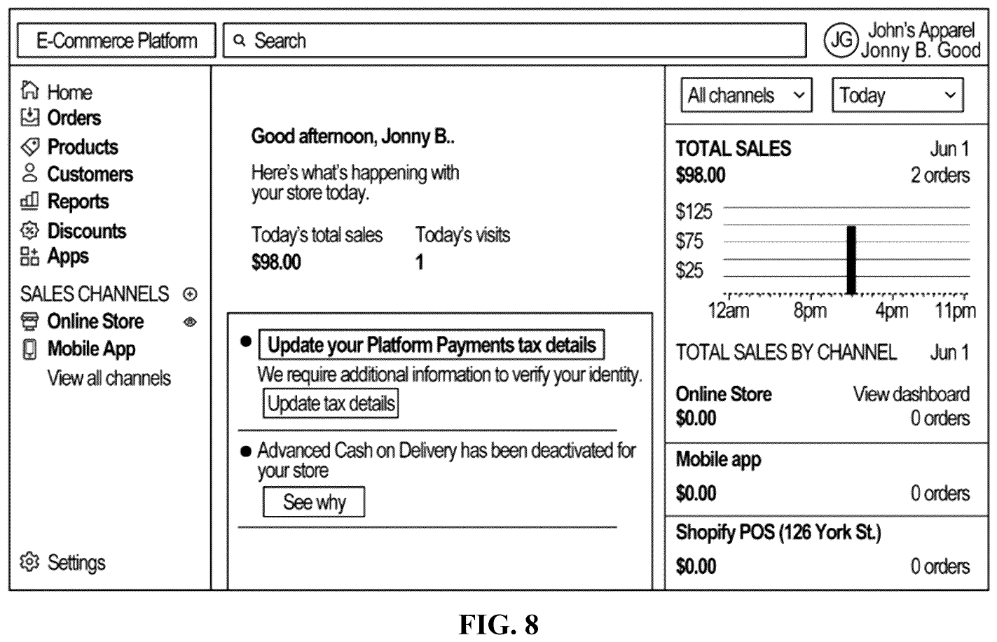

FIG. 8 depicts a non-limiting embodiment for a home page of an administrator 714. The administrator 714 may be referred to as an administrative console and/or an administrator console. The administrator 714 may show information about daily tasks, a store's recent activity, and the next steps a merchant can take to build their business. In some embodiments, a merchant may log in to the administrator 714 via a merchant device 702 (e.g., a desktop computer or mobile device), and manage aspects of their online store 738, such as, for example, viewing the online store's 738 recent visit or order activity, updating the online store's 738 catalog, managing orders, and/or the like. In some embodiments, the merchant may be able to access the different sections of the administrator 714 by using a sidebar, such as the one shown on FIG. 6. Sections of the administrator 714 may include various interfaces for accessing and managing core aspects of a merchant's business, including orders, products, customers, available reports and discounts. The administrator 714 may, additionally or alternatively, include interfaces for managing sales channels for a store including the online store 738, mobile application(s) made available to customers for accessing the store (Mobile App), POS devices, and/or a buy button. The administrator 714 may, additionally or alternatively, include interfaces for managing applications (apps) installed on the merchant's account; and settings applied to a merchant's online store 738 and account. A merchant may use a search bar to find products, pages, or other information in their store.

More detailed information about commerce and visitors to a merchant's online store 738 may be viewed through reports or metrics. Reports may include, for example, acquisition reports, behavior reports, customer reports, finance reports, marketing reports, sales reports, product reports, and custom reports. The merchant may be able to view sales data for different channels 710A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 738, such as based on account status, growth, recent customer activity, order updates, and the like. Notifications may be provided to assist a merchant with navigating through workflows configured for the online store 738, such as, for example, a payment workflow, an order fulfillment workflow, an order archiving workflow, a return workflow, and the like.

The e-commerce platform 700 may provide for a communications facility 729 and associated merchant interface for providing electronic communications and marketing, such as utilizing an electronic messaging facility for collecting and analyzing communication interactions between merchants, customers, merchant devices 702, customer devices 750, POS devices 752, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 729 is configured to provide automated responses to customer requests and/or provide recommendations to the merchant on how to respond such as, for example, to improve the probability of a sale.

The e-commerce platform 700 may provide a financial facility 720 for secure financial transactions with customers, such as through a secure card server environment. The e-commerce platform 700 may store credit card information, such as in payment card industry data (PCI) environments (e.g., a card server), to reconcile financials, bill merchants, perform automated clearing house (ACH) transfers between the e-commerce platform 700 and a merchant's bank account, and the like. The financial facility 720 may also provide merchants and buyers with financial support, such as through the lending of capital (e.g., lending funds, cash advances, and the like) and provision of insurance. In some embodiments, online store 738 may support a number of independently administered storefronts and process a large volume of transactional data on a daily basis for a variety of products and services. Transactional data may include any customer information indicative of a customer, a customer account or transactions carried out by a customer such as. for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 700. In some embodiments, the e-commerce platform 700 may store this data in a data facility 734. Referring again to FIG. 7, in some embodiments the e-commerce platform 700 may include a commerce management engine 736 such as may be configured to perform various workflows for task automation or content management related to products, inventory, customers, orders, suppliers, reports, financials, risk and fraud, and the like. In some embodiments, additional functionality may, additionally or alternatively, be provided through applications 742A-B to enable greater flexibility and customization required for accommodating an ever-growing variety of online stores, POS devices, products, and/or services. Applications 742A may be components of the e-commerce platform 700 whereas applications 742B may be provided or hosted as a third-party service external to e-commerce platform 700. The commerce management engine 736 may accommodate store-specific workflows and in some embodiments, may incorporate the administrator 714 and/or the online store 738.

Implementing functions as applications 742A-B may enable the commerce management engine 736 to remain responsive and reduce or avoid service degradation or more serious infrastructure failures, and the like.

Although isolating online store data can be important to maintaining data privacy between online stores 738 and merchants, there may be reasons for collecting and using cross-store data, such as for example, with an order risk assessment system or a platform payment facility, both of which require information from multiple online stores 738 to perform well. In some embodiments, it may be preferable to move these components out of the commerce management engine 736 and into their own infrastructure within the e-commerce platform 700.

Platform payment facility 720 is an example of a component that utilizes data from the commerce management engine 736 but is implemented as a separate component or service. The platform payment facility 720 may allow customers interacting with online stores 738 to have their payment information stored safely by the commerce management engine 736 such that they only have to enter it once. When a customer visits a different online store 738, even if they have never been there before, the platform payment facility 720 may recall their information to enable a more rapid and/or potentially less-error prone (e.g., through avoidance of possible mis-keying of their information if they needed to instead re-enter it) checkout. This may provide a cross-platform network effect, where the e-commerce platform 700 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 738.

For functions that are not included within the commerce management engine 736, applications 742A-B provide a way to add features to the e-commerce platform 700 or individual online stores 738. For example, applications 742A-B may be able to access and modify data on a merchant's online store 738, perform tasks through the administrator 714, implement new flows for a merchant through a user interface (e.g., that is surfaced through extensions/API), and the like. Merchants may be enabled to discover and install applications 742A-B through application search, recommendations, and support 728. In some embodiments, the commerce management engine 736, applications 742A-B, and the administrator 714 may be developed to work together. For instance, application extension points may be built inside the commerce management engine 736, accessed by applications 742A and 742B through the interfaces 740B and 740A to deliver additional functionality, and surfaced to the merchant in the user interface of the administrator 714.

In some embodiments, applications 742A-B may deliver functionality to a merchant through the interface 740A-B, such as where an application 742A-B is able to surface transaction data to a merchant (e.g., App: “Engine, surface my app data in the Mobile App or administrator 714”), and/or where the commerce management engine 736 is able to ask the application to perform work on demand (Engine: “App, give me a local tax calculation for this checkout”).

Applications 742A-B may be connected to the commerce management engine 736 through an interface 740A-B (e.g., through REST (REpresentational State Transfer) and/or GraphQL APIs) to expose the functionality and/or data available through and within the commerce management engine 736 to the functionality of applications. For instance, the e-commerce platform 700 may provide API interfaces 740A-B to applications 742A-B which may connect to products and services external to the platform 700. The flexibility offered through use of applications and APIs (e.g., as offered for application development) enable the e-commerce platform 700 to better accommodate new and unique needs of merchants or to address specific use cases without requiring constant change to the commerce management engine 736. For instance, shipping services 722 may be integrated with the commerce management engine 736 through a shipping or carrier service API, thus enabling the e-commerce platform 700 to provide shipping service functionality without directly impacting code running in the commerce management engine 736.

Depending on the implementation, applications 742A-B may utilize APIs to pull data on demand (e.g., customer creation events, product change events, or order cancelation events, etc.) or have the data pushed when updates occur. A subscription model may be used to provide applications 742A-B with events as they occur or to provide updates with respect to a changed state of the commerce management engine 736. In some embodiments, when a change related to an update event subscription occurs, the commerce management engine 736 may post a request, such as to a predefined callback URL. The body of this request may contain a new state of the object and a description of the action or event. Update event subscriptions may be created manually, in the administrator facility 714, or automatically (e.g., via the API 740A-B). In some embodiments, update events may be queued and processed asynchronously from a state change that triggered them, which may produce an update event notification that is not distributed in real-time or near-real time.

In some embodiments, the e-commerce platform 700 may provide one or more of application search, recommendation and support 728. Application search, recommendation and support 728 may include developer products and tools to aid in the development of applications, an application dashboard (e.g., to provide developers with a development interface, to administrators for management of applications, to merchants for customization of applications, and the like), facilities for installing and providing permissions with respect to providing access to an application 742A-B (e.g., for public access, such as where criteria must be met before being installed, or for private use by a merchant), application searching to make it easy for a merchant to search for applications 742A-B that satisfy a need for their online store 738, application recommendations to provide merchants with suggestions on how they can improve the user experience through their online store 738, and the like. In some embodiments, applications 742A-B may be assigned an application identifier (ID), such as for linking to an application (e.g., through an API), searching for an application, making application recommendations, and the like.

Applications 742A-B may be grouped roughly into three categories: customer-facing applications, merchant-facing applications, integration applications, and the like. Customer-facing applications 742A-B may include an online store 738 or channels 710A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 742A-B may include applications that allow the merchant to administer their online store 738 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 712 and payment gateways 706.

As such, the e-commerce platform 700 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 710A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 710A-B such as, for example, the merchant's online store 738, a physical storefront through a POS device 752; an electronic marketplace, through an electronic buy button integrated into a website or a social media channel). In some cases, channels 710A-B may be modeled as applications 742A-B A merchandising component in the commerce management engine 736 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 736 may be configured to receive customer information to complete the order such as the customer's contact information, billing information and/or shipping details. If the customer inputs their contact information but does not proceed to payment, the e-commerce platform 700 may (e.g., via an abandoned checkout component) to transmit a message to the customer device 750 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 736 may be configured to communicate with various payment gateways and services 706 (e.g., online payment systems, mobile payment systems, digital wallets, credit card gateways) via a payment processing component. The actual interactions with the payment gateways 706 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 736 may record where variants are stocked, and tracks quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 736 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 736. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 700 may make the merchant aware of compliance issues with respect to legal obligations (e.g., with respect to taxes). In some embodiments, the e-commerce platform 700 may enable merchants to keep track of changes to the contract of sales over time, such as implemented through a sales model component (e.g., an append-only date-based ledger that records sale-related events that happened to an item).

### Implementation in an E-commerce Platform

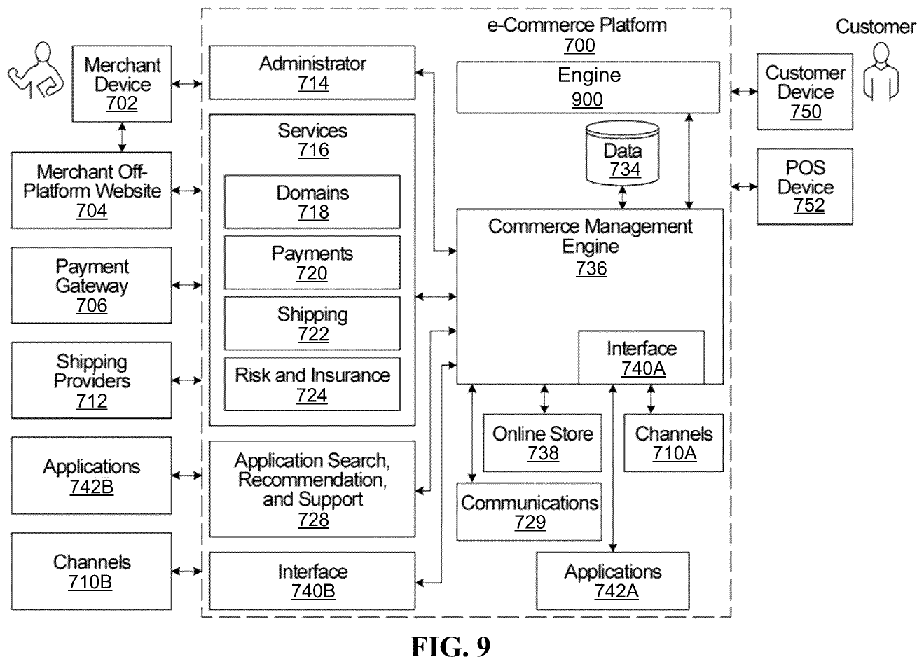

The functionality described herein may be used in commerce to provide improved customer or buyer experiences. The e-commerce platform 700 could implement the functionality for any of a variety of different applications, examples of which are described elsewhere herein. FIG. 9 illustrates the e-commerce platform 700 of FIG. 7 but including an engine 900. The engine 700 is an example of a computer-implemented system that implements the functionality described herein for use by the e-commerce platform 700, the customer device 750 and/or the merchant device 702.

Although the engine 700 is illustrated as a distinct component of the e-commerce platform 700 in FIG. 9, this is only an example. An engine could also or instead be provided by another component residing within or external to the e-commerce platform 700. In some embodiments, either or both of the applications 742A-B provide an engine that implements the functionality described herein to make it available to customers and/or to merchants. Furthermore, in some embodiments, the commerce management engine 736 provides that engine. However, the location of the engine 700 is implementation specific. In some implementations, the engine 700 is provided at least in part by an e-commerce platform, either as a core function of the e-commerce platform or as an application or service supported by or communicating with the e-commerce platform. Alternatively, the engine 700 may be implemented as a stand-alone service to clients such as a customer device 750 or a merchant device 702. In addition, at least a portion of such an engine could be implemented in the merchant device 702 and/or in the customer device 750. For example, the customer device 750 could store and run an engine locally as a software application.

The engine 700 could implement at least some of the functionality described herein. Although the embodiments described herein may be implemented in association with an e-commerce platform, such as (but not limited to) the e-commerce platform 700, the embodiments described herein are not limited to e-commerce platforms.

### Example Embodiments

Clause 1. A computer-implemented method, comprising: obtaining a first embedding in an embedding space, the first embedding representing a first item in an item store; identifying, based on at least a second embedding representing a second item in the item store, an item from the item store, wherein the second embedding is in the embedding space, and the identified item is identified based on a position of the second embedding in the embedding space relative to a position of the first embedding in the embedding space; and outputting an identification of the identified item.

Clause 2. The computer-implemented method of clause 1, wherein embeddings in the embedding space represent features of corresponding items of the item store within a plurality of feature dimensions, the method further comprising: obtaining a selection of a feature dimension of the plurality of feature dimensions; responsive to receiving the selection of the feature dimension of the plurality of feature dimensions, identifying the identified item in the item store, wherein the identified item in the item store is the second item represented by the second embedding, and wherein the second item is identified based on the second embedding having a feature that is within a threshold distance of a corresponding feature of the first item along the selected feature dimension.

Clause 3. The computer-implemented method of clause 2, further comprising: sending the first embedding to a large language model to output a descriptor for each of the plurality of feature dimensions based on the first embedding; and presenting the descriptor output by the large language model for each of the plurality of feature dimensions.

Clause 4. The computer-implemented method of clause 2, further comprising: decomposing aesthetic concepts of the first item to obtain an indication for each feature dimension in the plurality of feature dimensions; and outputting the indication for each feature dimension in the plurality of feature dimensions for display.

Clause 5. The computer-implemented method of clause 2, wherein obtaining the selection of the feature dimension of the plurality of feature dimensions comprises: obtaining a third embedding that represents a third item in the item repository; identifying a similar feature between the first item and the third item based on a similarity between the first embedding and the third embedding; and identifying a feature dimension corresponding to the similar feature as the selection of the feature dimension of the plurality of feature dimensions.

Clause 6. The computer-implemented method of clause 2, wherein obtaining the selection of the feature dimension of the plurality of feature dimensions comprises: obtaining a plurality of additional embeddings that represent corresponding additional items in the item repository; and identifying a respective similar feature between each additional item and the first item based on a similarity between each additional embedding and the first embedding; identifying a feature dimension corresponding to each of the respective similar features each as the selection of the feature dimension of the plurality of feature dimensions.

Clause 7. The computer-implemented method of clause 2, wherein obtaining the selection of the feature dimension of the plurality of feature dimensions comprises: generating multiple embeddings for the first item, each embedding of the multiple embeddings representing features of the first item; and presenting an indication of at least a first feature dimension from a first embedding associated with the first item and a second feature dimension from a second embedding associated with the first item; wherein the selection of the feature dimension of the plurality of feature dimensions comprises a selection of the first feature dimension or the second feature dimension.

Clause 8. The computer-implemented method of clause 2, further comprising: receiving an indication that a user is agnostic to a second feature dimension of the plurality of feature dimensions; wherein identifying the identified item in the item store comprises identifying the identified item based on the second embedding having a feature that is with a threshold distance of a corresponding feature of the first item along each of the feature dimensions of the plurality of feature dimensions other than the second feature dimension.

Clause 9. The computer-implemented method of clause 2, further comprising: after identifying the identified item, determining a point along the selected feature dimension that has a greater distance to the first embedding than a distance between the second embedding and the first embedding; identifying a third item from the item store based on a third embedding representing the third item, wherein the third embedding is in the embedding space, and the third item is identified based on a position of the third embedding in the embedding space relative to a position of the determined point; and outputting an identification of the third item.

Clause 10. The computer-implemented method of clause 2, further comprising presenting an indication for each feature dimension in the plurality of feature dimensions by displaying a slider on a user interface, wherein the slider is manipulable to select a degree of a feature dimension to apply to a search of the item store; wherein the threshold distance between the second embedding and the selected dimension is determined based on a position of the slider as manipulated.

Clause 11. The computer-implemented method of clause 2, further comprising presenting an indication for each feature dimension in the plurality of feature dimensions by displaying a circular grid that represents multiple feature dimensions at different angular positions around the circular grid; and displaying a marker on the circular grid that is manipulable to select a location on the circular grid; wherein the threshold distance between the second embedding and the selected dimension is determined based on the selected location on the circular grid.

Clause 12. The computer-implemented method of clause 1, further comprising: obtaining the second embedding; generating an interpolation between the first embedding and the second embedding; and identifying the identified item based on an identification of a third embedding representing a third item in the item store, wherein the identified item is the third item, and wherein the third embedding is identified based on a distance between the third embedding and a point along the interpolation.

Clause 13. The computer-implemented method of clause 12, further comprising: identifying the third embedding based on the distance between the third embedding and the point along the interpolation by performing a vector search of the repository of items to retrieve an embedding nearest to the point along the interpolation.

Clause 14. The computer-implemented method of clause 12, further comprising identifying the third embedding based on the distance between the third embedding and the point along the interpolation by: performing a vector search of the item store to retrieve a plurality of embeddings that are within a threshold distance of the point along the interpolation; and selecting the third embedding based on a distance between the third embedding and the second embedding being less than a distance between another embedding in the plurality of embeddings and the second embedding.

Clause 15. The computer-implemented method of clause 12, further comprising identifying the third embedding based on the distance between the third embedding and the point along the interpolation by: performing a vector search to retrieve a plurality of embeddings that are within a threshold distance of the point along the interpolation; and selecting the third embedding from the plurality of embeddings based on an attribute of the third item corresponding to the third embedding.

Clause 16. The computer-implemented method of claim 12, further comprising identifying the third embedding based on the distance between the third embedding and the point along the interpolation by: performing a vector search to retrieve a plurality of embeddings that are within a threshold distance of the point along the interpolation; applying a clustering algorithm to the plurality of embeddings to identify one or more clusters of the embeddings in the plurality of embeddings; and selecting the third embedding from the plurality of embeddings based on the third embedding being part of a largest cluster of the one or more identified clusters.

Clause 17. The computer-implemented method of clause 12, wherein generating the interpolation between the first embedding and the second embedding comprises: determining a line in a vector space from the first embedding to the second embedding.

Clause 18. The computer-implemented method of clause 17, further comprising: dividing the line into one or more points with a specified distance between each point; and identifying the third embedding that is similar to a point along the interpolation comprises identifying the third embedding based on distance between the third embedding and a respective point of the one or more points.

Clause 19. The computer-implemented method of clause 18, further comprising: dividing the line into a specified number of points; and for each respective point of the specified number of points, identifying a corresponding third embedding based on a distance between the corresponding third embedding and the respective point.

Clause 20. The computer-implemented method of clause 19, further comprising selecting the specified number of points based on a distance between the first embedding and the second embedding.

Clause 21. The computer-implemented method of clause 12, wherein generating the interpolation between the first embedding and the second embedding comprises: reducing a dimensionality of the first embedding and the second embedding to a lower-dimensional vector space; and determining a line in the lower-dimensional vector space from the reduced-dimensionality first embedding to the reduced-dimensionality second embedding.

Clause 22. The computer-implemented method of clause 12, wherein generating the interpolation between the first embedding and the second embedding comprises: determining a non-linear path from the first embedding to the second embedding.

Clause 23. The computer-implemented method of clause 12, wherein obtaining the first embedding and the second embedding comprises: receiving a user input to select the first item and the second item; and accessing the first embedding and the second embedding based on the user input.

Clause 24. The computer-implemented method of clause 12, wherein obtaining the second embedding comprises: receiving a description of the second item; causing a generative artificial intelligence model to output an image of the second item based on the received description; and generating the second embedding to represent the image of the second item.

Clause 25. The computer-implemented method of clause 12, wherein outputting the identification of the third item comprises: presenting a slider on a user interface, wherein a position of the slider is manipulable to represent a corresponding location within the embedding space between the first embedding and the second embedding; and displaying an image of the third item when the position of the slider as manipulated corresponds to the point along the interpolation.

Clause 26. The computer-implemented method of clause 12, wherein outputting the identification of the third item comprises: presenting an interactive representation of the embedding space between the first embedding and the second embedding, wherein one or more indicators for respective third items are displayed at positions within the interactive representation that corresponding to relative distances between respective third embeddings and the first embedding or the second embedding; and in response to a user selection of an indicator on the interactive representation, displaying an image of the respective third item that corresponding to the selected indicator.

Clause 27. A non-transitory computer readable storage medium storing executable instructions, execution of which by a processor causing the processor to: obtain a first embedding in an embedding space, the first embedding representing a first item in an item store; identify, based on at least a second embedding representing a second item in the item store, an item from the item store, wherein the second embedding is in the embedding space, and the identified item is identified based on a position of the second embedding in the embedding space relative to a position of the first embedding in the embedding space; and output an identification of the identified item.

Clause 28. A system comprising: at least one hardware processor; and at least one non-transitory memory storing instructions, which, when executed by the at least one hardware processor, cause the system to: obtain a first embedding in an embedding space, the first embedding representing a first item in an item store; identify, based on at least a second embedding representing a second item in the item store, an item from the item store, wherein the second embedding is in the embedding space, and the identified item is identified based on a position of the second embedding in the embedding space relative to a position of the first embedding in the embedding space; and output an identification of the identified item.

### Remarks

The terms “example”, “embodiment” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

We claim:

1. A computer-implemented method, comprising:
obtaining a first embedding in an embedding space, the first embedding representing a first item in an item store;
identifying, based on at least a second embedding representing a second item in the item store, an item from the item store, wherein the second embedding is in the embedding space, and the identified item is identified based on a position of the second embedding in the embedding space relative to a position of the first embedding in the embedding space; and
outputting an identification of the identified item.

2. The computer-implemented method of claim 1, wherein embeddings in the embedding space represent features of corresponding items of the item store within a plurality of feature dimensions, the method further comprising:
obtaining a selection of a feature dimension of the plurality of feature dimensions; and
responsive to receiving the selection of the feature dimension of the plurality of feature dimensions, identifying the identified item in the item store, wherein the identified item in the item store is the second item represented by the second embedding, and wherein the second item is identified based on the second embedding having a feature that is within a threshold distance of a corresponding feature of the first item along the selected feature dimension.

3. The computer-implemented method of claim 2, further comprising:
sending the first embedding to a large language model to output a descriptor for each of the plurality of feature dimensions based on the first embedding; and
presenting the descriptor output by the large language model for each of the plurality of feature dimensions.

4. The computer-implemented method of claim 2, further comprising:
decomposing aesthetic concepts of the first item to obtain an indication for each feature dimension in the plurality of feature dimensions; and
outputting the indication for each feature dimension in the plurality of feature dimensions for display.

5. The computer-implemented method of claim 2, wherein obtaining the selection of the feature dimension of the plurality of feature dimensions comprises:
obtaining a third embedding that represents a third item in the item store;
identifying a similar feature between the first item and the third item based on a similarity between the first embedding and the third embedding; and
identifying a feature dimension corresponding to the similar feature as the selection of the feature dimension of the plurality of feature dimensions.

6. The computer-implemented method of claim 2, wherein obtaining the selection of the feature dimension of the plurality of feature dimensions comprises:
obtaining a plurality of additional embeddings that represent corresponding additional items in the item store;
identifying a respective similar feature between each additional item and the first item based on a similarity between each additional embedding and the first embedding; and
identifying a feature dimension corresponding to each of the respective similar features each as the selection of the feature dimension of the plurality of feature dimensions.

7. The computer-implemented method of claim 2, wherein obtaining the selection of the feature dimension of the plurality of feature dimensions comprises:
generating multiple embeddings for the first item, each embedding of the multiple embeddings representing features of the first item; and
presenting an indication of at least a first feature dimension from a first embedding associated with the first item and a second feature dimension from a second embedding associated with the first item;
wherein the selection of the feature dimension of the plurality of feature dimensions comprises a selection of the first feature dimension or the second feature dimension.

8. The computer-implemented method of claim 2, further comprising:
receiving an indication that a user is agnostic to a second feature dimension of the plurality of feature dimensions;
wherein identifying the identified item in the item store comprises identifying the identified item based on the second embedding having a feature that is with a threshold distance of a corresponding feature of the first item along each of the feature dimensions of the plurality of feature dimensions other than the second feature dimension.

9. The computer-implemented method of claim 2, further comprising:
after identifying the identified item, determining a point along the selected feature dimension that has a greater distance to the first embedding than a distance between the second embedding and the first embedding;
identifying a third item from the item store based on a third embedding representing the third item, wherein the third embedding is in the embedding space, and the third item is identified based on a position of the third embedding in the embedding space relative to a position of the determined point; and
outputting an identification of the third item.

10. The computer-implemented method of claim 1, further comprising:
obtaining the second embedding;
generating an interpolation between the first embedding and the second embedding; and
identifying the identified item based on an identification of a third embedding representing a third item in the item store, wherein the identified item is the third item, and wherein the third embedding is identified based on a distance between the third embedding and a point along the interpolation.

11. The computer-implemented method of claim 10, further comprising:
identifying the third embedding based on the distance between the third embedding and the point along the interpolation by performing a vector search of the item store to retrieve an embedding nearest to the point along the interpolation.

12. The computer-implemented method of claim 10, further comprising identifying the third embedding based on the distance between the third embedding and the point along the interpolation by:
performing a vector search of the item store to retrieve a plurality of embeddings that are within a threshold distance of the point along the interpolation; and
selecting the third embedding based on a distance between the third embedding and the second embedding being less than a distance between another embedding in the plurality of embeddings and the second embedding.

13. The computer-implemented method of claim 10, further comprising identifying the third embedding based on the distance between the third embedding and the point along the interpolation by:
performing a vector search to retrieve a plurality of embeddings that are within a threshold distance of the point along the interpolation; and
selecting the third embedding from the plurality of embeddings based on an attribute of the third item corresponding to the third embedding.

14. The computer-implemented method of claim 10, further comprising identifying the third embedding based on the distance between the third embedding and the point along the interpolation by:
performing a vector search to retrieve a plurality of embeddings that are within a threshold distance of the point along the interpolation;
applying a clustering algorithm to the plurality of embeddings to identify one or more clusters of the embeddings in the plurality of embeddings; and
selecting the third embedding from the plurality of embeddings based on the third embedding being part of a largest cluster of the one or more identified clusters.

15. The computer-implemented method of claim 10, wherein generating the interpolation between the first embedding and the second embedding comprises:
determining a line in a vector space from the first embedding to the second embedding.

16. The computer-implemented method of claim 15, further comprising:
dividing the line into one or more points with a specified distance between each point; and
identifying the third embedding that is similar to a point along the interpolation comprises identifying the third embedding based on distance between the third embedding and a respective point of the one or more points.

17. The computer-implemented method of claim 16, further comprising:
dividing the line into a specified number of points; and
for each respective point of the specified number of points, identifying a corresponding third embedding based on a distance between the corresponding third embedding and the respective point.

18. The computer-implemented method of claim 17, further comprising selecting the specified number of points based on a distance between the first embedding and the second embedding.

19. The computer-implemented method of claim 10, wherein generating the interpolation between the first embedding and the second embedding comprises:
reducing a dimensionality of the first embedding and the second embedding to a lower-dimensional vector space; and
determining a line in the lower-dimensional vector space from the reduced-dimensionality first embedding to the reduced-dimensionality second embedding.

20. The computer-implemented method of claim 10, wherein generating the interpolation between the first embedding and the second embedding comprises:
determining a non-linear path from the first embedding to the second embedding.

21. The computer-implemented method of claim 10, wherein obtaining the first embedding and the second embedding comprises:
receiving a user input to select the first item and the second item; and
accessing the first embedding and the second embedding based on the user input.

22. The computer-implemented method of claim 10, wherein obtaining the second embedding comprises:
receiving a description of the second item;
causing a generative artificial intelligence model to output an image of the second item based on the received description; and
generating the second embedding to represent the image of the second item.

23. A non-transitory computer readable storage medium storing executable instructions, execution of which by a processor causing the processor to:
obtain a first embedding in an embedding space, the first embedding representing a first item in an item store;
identify, based on at least a second embedding representing a second item in the item store, an item from the item store, wherein the second embedding is in the embedding space, and the identified item is identified based on a position of the second embedding in the embedding space relative to a position of the first embedding in the embedding space; and
output an identification of the identified item.

24. A system comprising:
at least one hardware processor; and
at least one non-transitory memory storing instructions, which, when executed by the at least one hardware processor, cause the system to:
obtain a first embedding in an embedding space, the first embedding representing a first item in an item store;
identify, based on at least a second embedding representing a second item in the item store, an item from the item store, wherein the second embedding is in the embedding space, and the identified item is identified based on a position of the second embedding in the embedding space relative to a position of the first embedding in the embedding space; and
output an identification of the identified item.
